(19) United States
(12) Patent Application Publication
(10) Pub. No.: US 2022/0028215 A1
(43) Pub. Date: Jan. 27, 2022

(54) PLAY BY PLAY PARLAY

(71) Applicant: AdrenalineIP, Washington, DC (US)

(72) Inventors: Casey Alexander HUKE, Washington, DC (US); John CRONIN, Jericho, VT (US); Michael D'ANDREA, Burlington, VT (US)

(73) Assignee: AdrenalineIP, Washington, DC (US)

(21) Appl. No.: 17/079,860

(22) Filed: Oct. 26, 2020

Related U.S. Application Data
(60) Provisional application No. 63/054,415, filed on Jul. 21, 2020.

(51) Int. Cl. G07F 17/32; G06Q 50/34

(52) U.S. Cl. CPC G07F 17/3244; G06Q 50/34; G07F 17/3288; G07F 17/323

(57) ABSTRACT

A method of wagering on a plurality of individual actions inside of a live event as a single wager or parlay. The user is presented with at least one live event on which they can wager on individual actions or plays inside of that live event. The user selects the first play or action they wish to wager on, and are then presented with options to parlay that wager with at least one more play or action. The user can continue to add plays or actions, after each of which the odds for the next play to be added are calculated and presented. When the user has finished constructing their parlay, the live event results are monitored to determine the wager result, and the user's account balance is updated accordingly.

### CROSS-REFERENCE TO RELATED APPLICATIONS

The present patent application claims benefit and priority to U.S. Provisional Patent Application No. 63/054,415 entitled “PLAY BY PLAY PARLAY” filed on Jul. 21, 2020 which is hereby incorporated by reference into the present disclosure.

### FIELD OF THE DISCLOSURE

The embodiments generally relate to wagering on a number of individual actions inside of a live event, for example, through an electronic device interface.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Parlays and other special games that allow a user to combine wagers on multiple events in order to manipulate the odds and payout are common in most forms of sports gambling.

Play by play wagering systems in sports gaming are in early stages of development and do not offer parlay type of wagering opportunities.

### SUMMARY

An exemplary embodiment provides a method for providing a parlay in a live sports game. The method may include retrieving live events and multiple possible actions within the live event, presenting the user with one or more wagering options and corresponding odds for the actions, combining one or more actions, calculating odds for the combination of actions based on historical play data, comparing the combination of actions to the result of the actions in the live event, and paying out the user according to the wagering option and result.

An embodiment further includes a method of enticing a user-bettor to place a bet on the last play of one game and the first play of the next scheduled game through the offer of improved odds, for example, to entice bettors to keep betting game after game. This would allow a user to parlay the last event within one game with the first event in another game in order to entice the user to continue to use the wagering platform. For example, the user may be able to bet on the last event of a game being a pass and the first event of another game to be a run and provide the user with increased odds. An embodiment further consists of a proprietary method of continuously building parlays for a series of events within a play. For example, in the wagering platform allowing a user to parlay the wagers for run, a run greater than 4 yards and the run results in a first down. This would provide the user with an increase of odds for the wager since it is a parlay. An embodiment may include a method of providing the option to users of a wagering platform to parlay a sequence of individual plays in order to increase the odds for a wager. Finally, an embodiment includes a method of parlaying the outcomes of drives or a series of events (i.e., with respect to sporting events). For example, a bettor could wager that the first drive will be a three and out, the second drive will end in a touchdown, and the third will be a punt, where the bettor tries to parlay only the outcomes of specific aggregated drives more so than just the specific play.

### BRIEF DESCRIPTIONS OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a play by play parlay, according to an embodiment.

FIG. 2 illustrates a base wagering module, according to an embodiment.

FIG. 3 illustrates a parlay module, according to an embodiment.

FIG. 4 illustrates a historical play database, according to an embodiment.

FIG. 5 illustrates a parlay payout table, according to an embodiment.

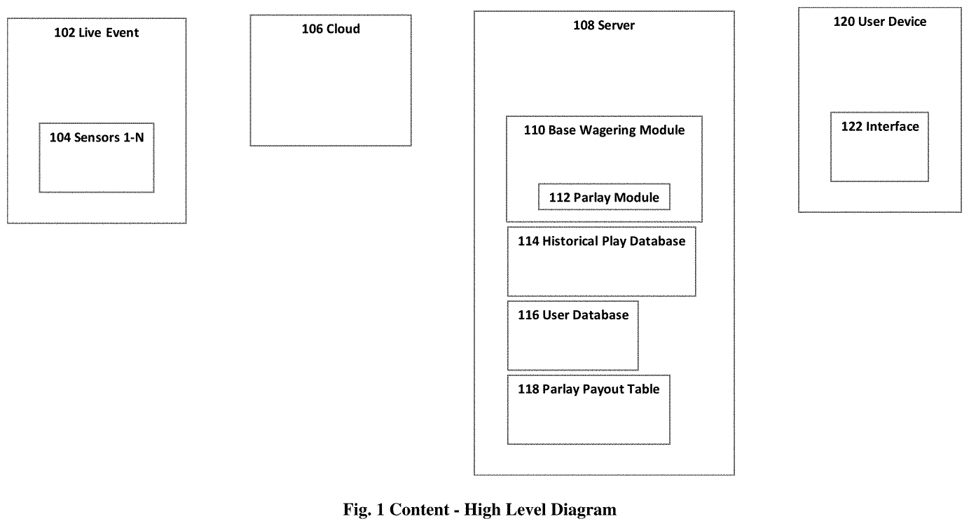

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “wager” or “bet.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick 'em” refers to a game when neither team is favored in an event or game. “Line”, “cover the spread”, “cover”, “tie”, “pick” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish”, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, of perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are a service that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allow customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, from creating and delivering actionable insights on performance to help customers to manage the sports gaming. Business Applications can be integrated into the embodiments in a variety of manners.

State based integration allows for a given sports gambling game to be modified by states in the United States or countries, based upon the state the player is in, based upon mobile phone or other geolocation identification means. State based integration can be integrated into the embodiments in a variety of manners.

Game Configurator allow for configuration of customer operators to have the opportunity to apply various chosen or newly created business rules on the game as well as to parametrize risk management. Game configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

This is a system for a play by play parlay. This system includes a live event 102, for example a sporting event such as a football game, basketball game, baseball game, hockey game, tennis match, golf tournament, eSports or digital game, etc. The live event will include some number of actions or plays, upon which a user or bettor or customer can place a bet or wager, typically through an entity called a sportsbook. There are numerous types of wagers the bettor can make, including, but not limited to, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event, such as the score of American football or the run line in baseball, or a series of action in the live event. Sportsbooks have an amount of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event or at another location.

The system may include a plurality of sensors 104 that may be used such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

The system also includes a cloud 106 or communication network. The communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance. The cloud may be communicatively coupled to server 108 which may perform real time analysis on the type of play and the result of the play. The cloud may also be synchronized with game situational data, such as the time of the game, the score, location on the field, weather conditions, and the like which may affect the choice of play utilized. For example, in other exemplary embodiments, the cloud may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein, at element 106. The system may include a server 108 which may perform real time analysis on the type of play and the result of a play or action. The server 108 (or cloud 106) may also be synchronized with game situational data, such as the time of the game, the score, location on the field, weather conditions, and the like which may affect the choice of play utilized. For example, in other exemplary embodiments, server 108 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein.

The server 108 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user. The base wagering module 110 allows the user to select the live event they wish to view available play or event based wagers, presents the user with the odds on those plays, collects individual wagers, monitors for play results and adjusts the users account balance according to the results. If the user wants to parlay multiple plays into one bet, the module 110 prompts the parlay module 112. The parlay module 112 allows the user to combine at least two plays into a single wager. It calculates the payout the odds for the parlay based on what followed similar plays in the historical play database. The historical play database 114 contains all of the play data available to the system for odds making. The user database 116 holds user account information as well as their current balance as it is updated by the base wagering module 110 based upon wager results. The parlay payout table 118 shows the method for calculating parlay odds and payouts. A user device 120 may include a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. The user device 120 can leverage the sensors in for purposes such as automatic content recognition, augmented reality or the synchronization of screens between the user device interface 122 and other displays. The interface(s) 122 may either accept inputs from users or provide outputs to the users, or may perform both the actions. In one case, a user can interact with the interface(s) 122 using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) 122 may either be implemented as a Command Line Interface (CLI), a Graphical User Interface (GUI), a voice interface, or a web-based user-interface.

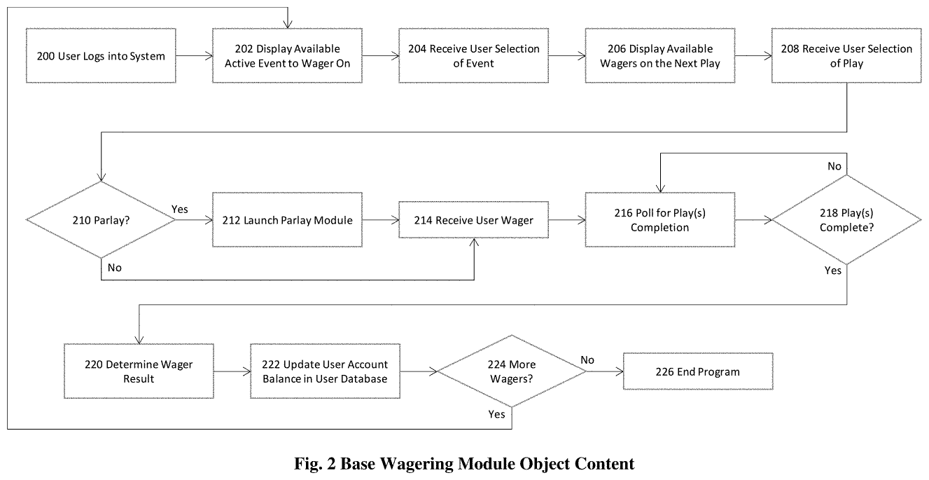

Functioning of the base wagering module 110 will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the base wagering module 110. The base wagering module 110 allows for the user to log in to the play by play wagering system hosted on the server 108, at step 200. The base wagering module 110 then displays all live events that are available to place play by play wagers on. Wager selection information can be a “bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “handle” or “juice” or “vigorish” or “off the board”. Play data can be any sensor data that indicates anything about the live game, including, but not limited to, audio or visual data that indicates “actions”, “sides”, “event” data, “total” data, “listed pitchers”, specific players, whistles, fouls, touchdowns, goals, yardage, player error, etc., at step 202. The base wagering module 110 then receives the user's selection of which event, such as an American football game between the New England Patriots and the New York Jets, at step 204. The base wagering module 110 will then display the wagers available for the next play in the game, at step 206. The base wagering module 110 then receives the user's selection of which play they wish to wager on, at step 208. The base wagering module 110 then allows the user elect to wager, for example, that the next play will be a pass of more than 10 yards by New England. The module will then ask the user if they wish to turn their bet into a multi-play parlay, at step 210. The base wagering module 110 allows the user to wager on a parlay, and the parlay module 112 is triggered, at step 212. The base wagering module 110 then proceeds with either the user's original single play wager, or the parlay wager returned from the parlay module 112, at step 214. The base wagering module 110 then polls for the completion of the play, for an individual play wager, or plays for a parlay wager, at step 216. If the play(s) are not complete, the base wagering module 110 returns to step 216. If the play(s) is(are) complete, the module proceeds forward, at step 218. The base wagering module 110, based on the result(s) of the completed play(s), calculate the wager result, at step 220. The base wagering module 110 allows for the account balance of the user to be updated based on the wager result, at step 222. The base wagering module 110 allows for the user to be polled for their desire to make more wagers, at step 224. The base wagering module 110 allows the user to elect to place another wager, and the module returns to step 202. If the user elects to make no more wagers, the program ends. If the game is over, the program may end. It should be noted that the base module can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 226.

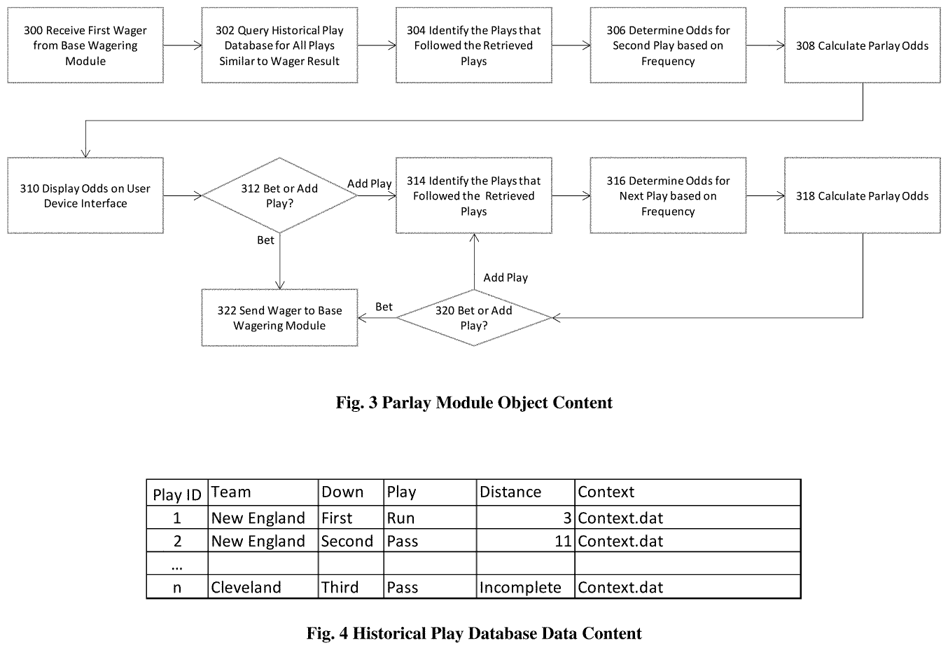

Functioning of the parlay module 112 will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the parlay module 112. The parlay module 112 allows for receiving a first play wager from the base wagering module 110, at step 300. The parlay module 112 then queries the historical play database for all plays with a similar outcome the player has wagered on in them in their initial, at step 302. The parlay module 112 allows for the definition of a similar outcome which can vary widely depending on the sport and the size of the available dataset of similar plays in the historical play database. For example, the user can bet that the New England Patriots would complete a pass of at least 10 yards on a third down and 8 play from their own 40 yard line, with 3 minutes to go in the first quarter of a September home game against the New York Jets, depending upon the size of dataset in the historical play database. Additionally, context factors could include the personnel of the field, the formation of the offense and defense, along with aspects of the weather, such as temperature, humidity, precipitation, etc. Other relevant factors could include past wagers made by the user or any other user or group of users. With a large enough dataset, all of the previously listed aspects of the play could be used to filter the dataset for similar plays. The number of context factors used to filter for similar plays needs to be balanced with keeping the size of the set of similar plays remaining is large enough to be statistically significant in the odds making system used by the system. Once a statistically significant dataset of plays similar to the user's initial wager is identified, the module will retrieve from the historical play database all of the plays that followed the identified plays similar to the user's initial wager, at step 304. The parlay module 112 allows for many methods of calculating odds. The example used in this embodiment distributes the odds across the retrieved second plays by the frequency with which they occurred, at step 306. The parlay module 112 then calculates the odds of the current parlay which are demonstrated in the parlay payout table 118, at step 308. The parlay module 112 allows for odds from the parlay payout module 118 to be presented to the user via the user device interface 122, at step 310. The parlay module 112 allows for the user to be given the option to place a bet on the display parlay or add another play to the parlay, at step 312. The parlay module 112 allows the user to elect to add an additional play to the parlay, the module queries the historical play database for all plays similar to the second play of the parlay in the same manner as is done in step 302, at step 314. The parlay module 112 allows for calculating the odds for the plays, and to identify similar plays as in the same manner as in step 304, at step 316. The parlay module 112 allows for the odds for the three play parlay are then calculated in the same manner as in step 308, at step 318. The parlay module 112 allows for the user to be given the option to place a bet on the display parlay or add another play to the parlay, at step 320. The parlay module 112 will continually loop through steps 314 to 318 as the user adds plays to their parlay. Once the user has finished adding plays and elects to place a wager, the module sends that wager to the base payout module at step 322.

Functioning of the historical play database 114 will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the historical play database 114. The historical play database 114 contains all the historical play data available to the system to determine odds. The first column is the play ID. The second column is the offensive team that ran that play. The third column is what down the play was run on; in other embodiments this could include the distance to a first down as well. The fourth column is the type of play run, such as a run, a pass, a kick, a punt, etc. The fifth column contains the results of the play, such as the yards gained or lost, an incomplete pass, points scored, etc. The sixth column is a data file containing all of the context factors the data can be sorted by to further filter the dataset being examined to determine odds. Examples of context include, the weather, the stadium the game is played in, the time in the game, the score of the game, the team's position on the field, etc. The larger the dataset, the more context factors can be used to filter the data. In an exemplary embodiment, the most context factors that still yield a statistically significant dataset would be used to calculate odds.

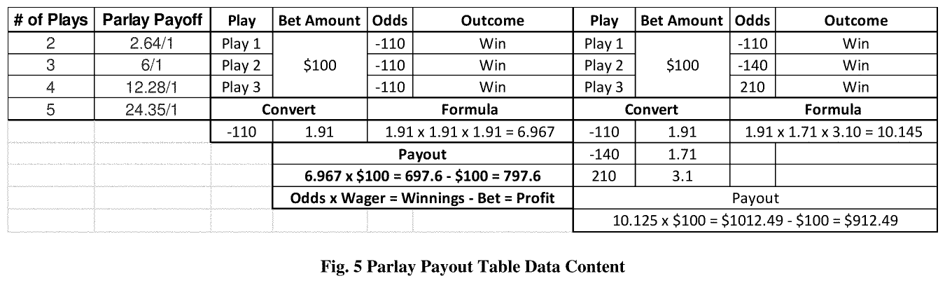

Functioning of the parlay payout table 118 will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the parlay payout table 118. The table contains the parlay odds and payout calculations that are well known in the art. The first two columns contain the standard odds in most sportsbooks for combining multiple games in a parlay. While the system could use non-standard parlay rates as an individual play is a different proposition that a game, but for the purposed of the example embodiment, we will use the standard parlay payouts in the first two columns. The next four columns contain an example of a successful three play parlay. The user elected to wager $100 on three plays with the same −110 odds for their parlay. −110 odds converts to 1.91 in decimal odds. The three decimal odds value are multiplied together to get the total payout for the parlay, in this example 6.967. That number is multiplied by the original wager of $100, to yield a total payout of $696.70, minus the original wager of $100 yields a total profit to the user of $596.70. The final four columns show the same equation but with three plays that had differing odds.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

The following list of claims replaces any prior listing of claims:

1. A method for providing a parlay in a live sports game, comprising:
retrieving at least one active live event comprising a plurality of actions upon which wagers can be placed,
presenting at least one wagering option on one or more of the plurality of actions inside of the live event, the first wagering option based on a first set of odds,
receiving a combination of additional actions to the wagering option, said combination configured to change odds or payout of the wagering option,
constructing a query based on the combination of actions and sequential timing information of the combination of actions;
filtering at least one of historical play data and past wager activity for at least one sequence of actions similar to the combination of actions based on the query;
recalculating odds based on a combined likelihood of the combination of actions as a whole within the wagering option based on the at least one of historical play data and past wager activity that is filtered for actions similar to the combination of actions,
comparing, with an automated content recognition (ACR) system communicatively coupled with a database, at least one data and/or media file from the live sporting event to a plurality of reference fingerprints in the database, and identifying, with the ACR, a result of at least one of the plurality of actions within the live sporting event based on a comparison between the at least one media file and the plurality of reference fingerprints, and
comparing the combination of actions to a result of the actions in the live event that is provided in metadata from the ACR, and resolving a wager based on the wagering option as a result of the comparison.

2. The method of claim 1, further comprising prompting a user to select additional wagers.

3. The method of claim 1, wherein the step of calculating the odds further comprises receiving one or more context factors relating to the live event, and updating the odds based on the context factors.

4. The method of claim 3, wherein the context factors comprise at least one of personnel of the field, a formation, and a weather condition.

5. A computer implemented method for providing a parlay in a live sports game, comprising executing on a processor the steps of:
displaying a betting game interface;
displaying one or more live events, each of the one or more live events comprising a plurality of actions;
displaying a parlay betting module;
displaying odds for a combination of two or more of the actions within one or more of the live events, said odds based on a combined probability of the two or more actions and based on sequential timing information of the two or more actions;
displaying wagers placed on the two or more actions before a first of the two or more actions in the one or more live events takes place; and
resolving the wagers placed on the one or more actions based on a comparison, with an automated content recognition (ACR) system communicatively coupled with a database, of at least one data and/or media file from the live sporting event to a plurality of reference fingerprints in the database, and based on an identification, with the processor, based on the comparison performed by the ACR and based on metadata received from the ACR on the processor, of a result of at least one of the two or more actions after the first of the two or more actions takes place.

6. The computer implemented method of claim 5, further comprising displaying a parlay payout table comprising a plurality of odds corresponding to a plurality of plays and combinations of plays.

7. The computer implemented method of claim 5, further comprising displaying a historical play database table comprising one or more historical plays.

8. The computer implemented method of claim 7, wherein the historical play database table further comprises one or more context factors corresponding to the one or more historical plays.

9. The computer implemented method of claim 8, wherein the one or more plays share one or more context factors.

10. A system for providing a parlay in a live sports game, comprising:
a base wagering module, wherein the base wagering module is configured to provide one or more wagering options and corresponding odds based on a plurality of actions occurring within one or more live events;
a parlay module, wherein the parlay module is configured to combine two or more of the plurality of actions and is configured to generate odds based on a selected combination of actions and sequential timing information for the selected combination of actions, said odds based on a combined probability of the two or more actions occurring according to a particular timing sequence;
a historical play database comprising a plurality of historical plays, and
an automated content recognition (ACR) system communicatively coupled with a database and configured to compare a plurality of data and/or media files from the live sporting events to a plurality of reference fingerprints in the database;
wherein the base wagering module is configured to calculate the odds based on the historical plays; and
wherein the ACR system is configured to identify, in the one or more live events, at least one matching reference fingerprint and provide metadata to a processor based on the at least one matching reference fingerprint, wherein the processor is configured to make a determination of whether any of the plurality of actions have occurred and resolve at least one wager based on said determination.

11. The system of claim 10, wherein the historical play database further comprises a plurality of context factors associated with the plurality of historical plays, and wherein the wagering options and odds are updated based on the context factors.

12. The system of claim 10, further comprising a parlay payout table, wherein the parlay payout table displays the wagering options and odds corresponding to a group of possible combinations of actions.

13. The system of claim 11, wherein the context factors comprise at least one of personnel of the field, a formation, and a weather condition.

14. The system of claim 10, wherein the base wagering module is configured to increase the odds associated with a selected combination of actions in favor of a user.
